(19) United States
(12) Patent Application Publication
(10) Pub. No.: US 2002/0131626 A1
(43) Pub. Date: Sep. 19, 2002

(54) Radiation sensor and radiation detector for a computed tomography apparatus

(76) Inventors: Gereon Vogtmeier, Aachen (DE); Francisco Morales Serrano, Aachen (DE); Stefan Schneider, Aachen (DE); Olaf Such, Aachen (DE)

Correspondence Address: U.S. Philips Corporation, 580 White Plains Road, Tarrytown, NY, 10591, US

(21) Appl. No.: 10/081,895

(22) Filed: Feb. 21, 2002

(30) Foreign Application Priority Data
Feb. 22, 2001 (DE) 10108430.7

(51) Int. Cl. G06K 9/00

(52) U.S. Cl. 382/131

(57) ABSTRACT

The invention relates to a radiation sensor (10) which is notably suitable for use in the radiation detector of a computed tomography apparatus. The radiation sensor (10) is preferably constructed as an integrated chip in the CMOS technique and is provided with photodiodes (11) which are arranged in the form of a matrix as well as with a temperature sensor (12). The output signals of the photodiodes (11) can be corrected in respect of temperature dependency by means of the output signals of the temperature sensor (12). The temperature sensor (12) preferably utilizes the same data format as the photodiodes (11), so that it can be addressed, read out and treated in the same way as the photodiodes (11) by an evaluation unit (13). The measured temperature value, furthermore, can be used for the detection of faults and/or ageing of the radiation sensor chip (10).

The invention relates to a radiation sensor of an integrated type as well as to a radiation detector which is provided with at least one radiation sensor of this kind and with an associated evaluation unit.

In radiation sensors with an integrated, microelectronic construction at least one light-sensitive and/or X-ray-sensitive sensor element is arranged on a chip, which sensor elements delivers an output signal whose strength indicates the amount of radiation absorbed by the sensor element. An X-ray sensor of this kind is disclosed, for example, in DE 42 27 096 A1. Radiation sensors which are sensitive to light and/or X-rays are described in DE 40 02 429 A1, EP 0 434 154 B1, and EP 0 440 282 B1. A radiation sensor of this kind is typically provided with a large number of sensor elements which are arranged in the form of a matrix. The sensor elements may be constructed, for example, as photodiodes in the case of a chip realized in the CMOS technique.

The functional relationship between the output signal of a sensor element and the absorbed amount of radiation is dependent on various factors; among these factors notably the temperature prevailing on the chip is of importance. For this reason it is desirable to compensate said factors so as to enable more accurate determination of the true value of the absorbed amount of radiation. In order to achieve this object, WO 99/03262 proposes to reserve two of the photoelements present on a photosensor chip to act as reference elements for compensation purposes. Unlike all other photoelements, such reference elements are not exposed to the light to be measured; instead, one of these elements is completely shielded from the light by way of a metallic layer whereas an external electrical current is impressed on the other element. The two reference elements thus represent the state of minimum and maximum exposure, respectively, of a light-sensitive photoelement, the corresponding output signals of the reference elements being subjected to the same further processing as the output signals of the other photoelements. The reference values thus derived from the two reference elements can be used in the electronic evaluation circuitry so as to correct the output signals of the measuring photoelements accordingly. Various interference effects which may have an effect on the generating and processing of the output signal of a light-sensitive photoelement are thus implicitly taken into account, for example, in particular temperature and voltage fluctuations, manufacturing tolerances and the like are thus dealt with. Separate detection of the individual effects, however, is not possible.

Therefore, it is an object of the present invention to provide a radiation sensor and a radiation detector which are particularly suitable for use in a computed tomography apparatus and enable differentiated and reliable evaluation of the measuring values.

This object is achieved by means of a radiation sensor in accordance with the invention as disclosed in the characterizing part of claim 1, by means of a radiation sensor as disclosed in the characterizing part of claim 2, as well as by means of a radiation detector as disclosed in the characterizing part of claim 7. Advantageous embodiments are disclosed in the dependent claims.

A first embodiment of the integrated radiation sensor is provided with at least one light-sensitive and/or X-ray-sensitive sensor element whose output signal indicates the amount of radiation absorbed thereby. The radiation sensor also includes at least one temperature sensor whose output signal indicates the temperature prevailing at the temperature sensor.

Thus, a temperature sensor is integrated on the chip of the radiation sensor in this embodiment, thus enabling direct and accurate determination of the temperature at the radiation sensor. This temperature corresponds to the temperature of the entire radiation sensor chip, because the chip has a substantially uniform temperature distribution because of its small dimensions. The exact arrangement of the temperature sensor, therefore, usually is not a critical factor. Preferably, however, the temperature sensor is arranged in such a location that it detects an as representative as possible temperature value in all cases. This location is situated, for example, at the center or in a symmetrically situated position on the chip.

Because the temperature prevailing on the chip is thus known, the output signals delivered by the light-sensitive and/or X-ray-sensitive sensor elements can be compensated in respect of temperature behavior, so that the true value of the absorbed amount of radiation can be determined. The integration of the temperature sensor in the chip itself provides maximum precision of the temperature measurement; such precision could not be achieved by means of an externally arranged temperature sensor. Furthermore, the integration of such a temperature sensor can be realized particularly economically during the manufacture of the radiation sensor chip.

A plurality of temperature sensors may also be distributed across the radiation sensor chip in order to enhance the measuring accuracy and to deal with possible failure of individual sensors so that, if desired, a temperature distribution across the chip and/or a mean temperature can be determined.

A second version of the invention concerns a radiation sensor of an integrated type which is provided again with at least one light-sensitive and/or X-ray-sensitive sensor element whose output signal is indicative of the amount of radiation absorbed by the sensor element. The radiation sensor is also provided with at least one further sensor element which is sensitive to a physical quantity other than that whereto the light-sensitive and/or X-ray-sensitive sensor elements are sensitive, the light-sensitive and/or X-ray-sensitive sensor elements and the further sensor element delivering similar output signals and being connectable to an evaluation unit as similar components.

The further sensor element may be, for example, a sensor for a magnetic field, for an acceleration, for electromagnetic radiation outside the already measured frequency range (X-rays when the primary sensor elements are light-sensitive; light when the primary sensor elements are X-ray sensitive; UV; infrared; etc.), for a force or a pressure, or for chemical substances. As described before, the further sensor element may also be a temperature sensor whose output signal indicates the temperature prevailing at the temperature sensor. It is important that the output signal of said further sensor element is in principle of the same type as the output signal of the light-sensitive and/or X-ray-sensitive sensor elements, that is, for example, a voltage signal, a charge signal or a current signal in the case of analog signals, or a signal of the same bit width as the digital output signals of the sensor elements in the case of digital signals. The light-sensitive and/or X-ray-sensitive sensor elements and the further sensor element, therefore, utilize the same data format, thus enabling these elements to be connected to an evaluation unit as similar components. The evaluation unit, therefore, does not differentiate whether it reads an output signal from a light-sensitive and/or X-ray-sensitive sensor element or an output signal from the further sensor element. This distinction is derived exclusively from the address of the unit wherefrom the output signal was read. In the case of a typical matrix-like arrangement of the sensor elements, the further sensor elements are thus provided with a given address in the same way as the light-sensitive and/or X-ray-sensitive sensor elements so that their output signal can be fetched from said address.

The described configuration of the radiation sensor offers the advantage that no special electronic evaluation circuitry is required for the further sensor element or elements and that reading out can be performed by the same evaluation unit which is also responsible for reading out the light-sensitive and/or X-ray-sensitive sensor elements.

In conformity with a preferred embodiment, the light-sensitive and/or X-ray-sensitive sensor elements are arranged in the form of a matrix of rows and columns on the radiation sensor. For example, for application in a computed tomography apparatus usually two or a few long rows of sensor elements are arranged adjacent one another. In the case of applications in the field of dynamic X-ray fluoroscopy, however, typically matrices with approximately 2000×2000 sensor elements are applied.

Those skilled in the art will see many alternatives in respect of the configuration of the additional sensor elements on the radiation sensor chip. In the case of a temperature sensor of the integrated type, this sensor preferably includes a current mirror with two parallel paths in which each time the same current flow occurs. In both paths there is provided a respective bipolar transistor and its emitter-collector path, the base of said transistor being short-circuited each time to the collector. The surface areas of said bipolar transistors differ. In such an arrangement the current that occurs in the current paths is approximately proportional to the temperature of the bipolar transistors.

A temperature sensor constructed in the described manner may also include a further current mirror that is connected parallel to said two current paths, the output current of this further current mirror being coupled out as the output current signal of the temperature sensor so as to be evaluated.

Alternatively, or additionally, a voltage can also be derived as the output signal of the temperature sensor. To this end, preferably the difference between the emitter-base voltages of the two bipolar transistors is derived by means of a coupling-out circuit so as to be presented as an output voltage for external use.

The invention also relates to a radiation detector that is suitable notably for use as an X-ray detector in an X-ray computed tomography apparatus. The radiation detector is provided with at least one radiation sensor of the kind set forth as well as with an associated evaluation unit for reading out and evaluating the output signals delivered by the radiation sensor. The radiation sensor thus includes a temperature sensor, or another sensor element, which is integrated on the chip; preferably, the data format used by said sensor element is the same as that used by the light-sensitive and/or X-ray-sensitive sensor elements. The evaluation unit of the imaging system can thus treat the output signals of the light-sensitive and/or X-ray-sensitive sensor elements and of the other sensor element in a similar way, so that it is not necessary to employ different circuits for the various sensor elements. The differentiated evaluation of the various signals instead is controlled exclusively via the software used.

When the radiation sensor includes at least one temperature sensor, the evaluation unit is preferably arranged in such a manner that it corrects the output signals of the light-sensitive and/or X-ray-sensitive sensor elements of the radiation sensor by means of the temperature value measured by the temperature sensor. The output signals of a light-sensitive and/or X-ray-sensitive element, for example, a photodiode on a CMOS chip, usually are strongly dependent on the temperature that prevails on the chip. The relationships are known in principle, so that when the temperature is known, a corresponding compensation for the temperature can be performed arithmetically or by means of a suitable circuit. When use is made of the temperature sensor integrated on the microchip, a particularly high precision of the correction can be achieved, because the temperature value thus detected very accurately corresponds to the true temperature of the sensor elements, that is, quasi without a time delay.

Furthermore, when use is made of a radiation sensor with a temperature sensor, the evaluation unit may be arranged in such a manner that it is capable of making a diagnosis of the operating condition of the radiation sensor on the basis of the measured temperature value. For example, incorrect functioning of the chip or the environment of the chip may give rise to an abnormal temperature increase on the chip; such an increase can be detected via the measured temperature value. Similarly, ageing of the chip can be detected by the temperature sensor on the basis of increased temperatures. Finally, in the case of complex arrangements which involve a plurality of radiation sensor chips, and are encountered notably in a computed tomography apparatus, it is also possible to determine the spatial temperature distribution and to recognize detrimental or incorrect temperature distributions in the arrangement. The reliability of the imaging system is thus significantly enhanced by the presence of the temperature sensor.

The invention will be described in detail hereinafter, by way of example, with reference to the Figures. Therein:

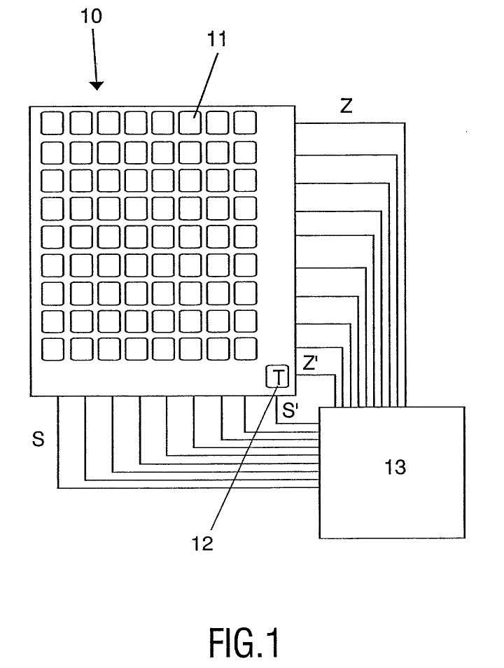

FIG. 1 shows diagrammatically the components of an X-ray detector in accordance with the present invention;

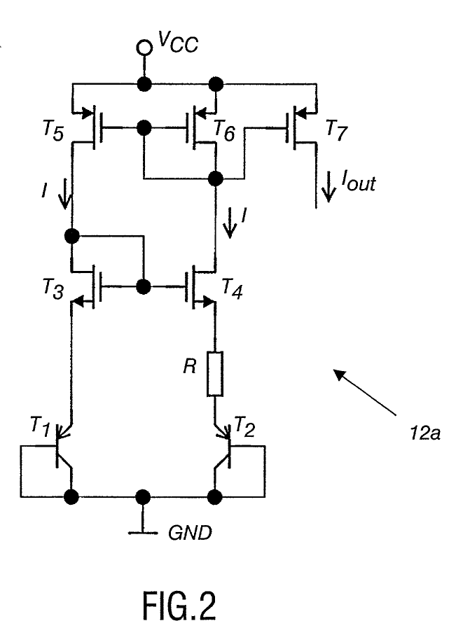

FIG. 2 shows a temperature sensor of an integrated type with an output current, and

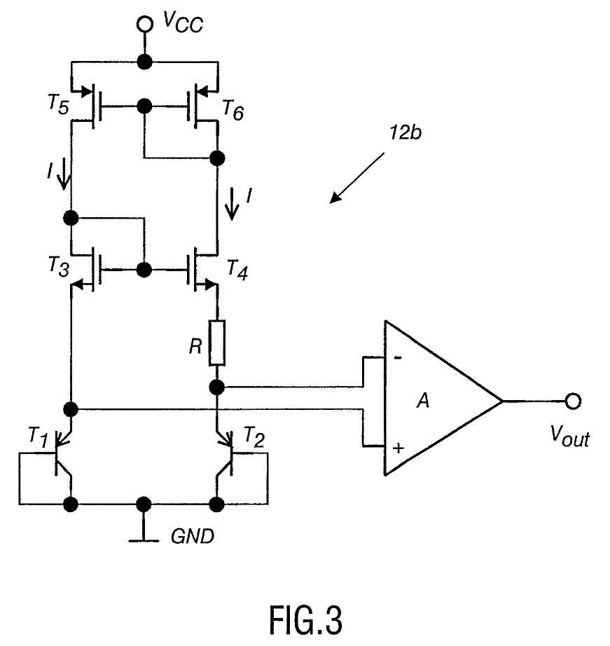

FIG. 3 shows a temperature sensor of an integrated type with an output voltage.

FIG. 1 shows diagrammatically the components of an X-ray detector which can be used, for example, in an X-ray computed tomography apparatus, so as to determine the fluorescent light emitted after the absorption of an X-ray quantum. The X-ray detector could alternatively be arranged for direct detection of absorbed X-ray quanta (see DE 42 27 096 A1). The X-ray detector is provided essentially with a radiation sensor chip 10 as well as with an evaluation unit 13 connected thereto. The radiation sensor chip 10 is preferably formed in accordance with the CMOS technique and is provided with light-sensitive sensor elements 11 which are distributed in the form of a matrix on a detector surface. These elements may be realized notably as photodiodes whose output delivers a voltage signal and/or a current signal which is essentially proportional to the absorbed quantity of light. Said output signals of the photodiodes 11 are read out by the evaluation 13 which is capable of addressing each photodiode 11 of the radiation sensor 10 via its row Z and its column S.

As is known, the output voltage generated by a photodiode is inter alia strongly dependent on the temperature at which the photodiode operates. In order to compensate this dependency and to derive the exact absorbed quantity of light from the output signal of the photodiode 11, therefore, it is important to know the temperature of the photodiode 11 as exactly as possible. Such knowledge of the temperature is obtained in accordance with the invention by means of at least one temperature sensor 12 provided on the chip 10. Because usually an approximately homogeneous temperature distribution occurs on the chip 10, the exact geometrical arrangement of the temperature sensor 12 is not very critical. Unlike the situation shown in FIG. 1, however, the temperature sensor may also be arranged at the center or in a central region of the chip 10 so as to ensure that an as representative as possible temperature value is determined. Furthermore, a plurality of such temperature sensors may also be provided; the temperature signal can be determined therefrom either in a redundant fashion or as a mean value. The integration of the temperature sensor 12 on the microchip 10 makes the temperature measurement particularly simple, without additional components or elements outside the chip being necessary.

Furthermore, the temperature sensor 12 is arranged in such a manner that it can be treated in the same way as the photopixels 11 by the evaluation unit 13, so that its addressing, driving and read out procedure can take place in the same way. Like the photodiodes 11, the temperature sensor 12 may notably be given a row/column address (Z′, S′), via which it can be addressed.

FIG. 2 shows a feasible circuit for a temperature sensor 12a which is integrated on a chip 10 and whose output delivers a current signal out. The complete microchip is realized in the CMOS technique and the CMOS transistors T₃, T₄, T₅ and T₆ form a current mirror. This current mirror consists of two parallel current paths between the supply voltage V_{cc} and ground GND, that is, a first path via the transistors T₅ and T₃ on the one side and a second path via the transistors T₆ and T₄ as well as the resistor R on the other side. Each of the transistors is connected in the current paths via its emitter-collector path. The bases of the transistors T₅ and T₆ and of the transistors T₃ and T₄ are coupled. Furthermore, the bases of the transistors T₅ and T₆ are connected to the connection lead between the transistors T₆ and T₄ and the bases of the transistors T₃ and T₄ are connected to the connection lead between the transistors T₅ and T₃. The current mirror keeps the current I in the two parallel current paths equal (for a general description of current mirrors see U. Tietze, Ch. Schenk, “Halbleiter-Schaltungstechnik,” chapter 4.1, 11th edition, 1999, Springer Verlag).

In both current paths, however, a respective bipolar transistor T₁ and T₂ is integrated via the emitter-collector paths, the collectors thereof being connected each time to ground (GND). The bipolar transistors T₁ and T₂ deviate only in respect of surface area, that is, by a factor n. The resistor R adjusts the current I through the current paths. The current I is directly proportional to the absolute temperature of the two bipolar transistors.

The current I itself is mirrored on the output as an output current lout by means of the CMOS transistor T₇; to this end a gain factor, may also be used, if necessary.

FIG. 3 shows an alternative version of the described circuit in the form of a temperature sensor 12b. The output now carries a voltage signal Vₒᵤₜ instead of a current signal. The difference between the emitter-base voltages of the two bipolar transistors T₁ and T₂ in the circuit is determined by means of a differential amplifier A. The output voltage is also proportional to the temperature of the two transistors. The slope of the temperature characteristic can be influenced when the differential amplifier has a gain factor.

In the feasible embodiments shown in the FIGS. 2 and 3, the integration of the temperature sensor 12a or 12b shown must be adapted to the relevant CMOS process. It can be optimized accordingly, so that the desired sensitivity and measuring range are realized.

The following advantages can be achieved by means of the arrangement shown in the FIGS. 1 to 3:

greater accuracy for the temperature compensation by direct measurement of the chip temperature;

direct access to the temperature information by quasi pixel addressing;

no additional elements and no additional costs for sensors and data acquisition;

uniform data format;

high local resolution of the temperature across the entire spine (in the case of computed tomography applications) by integration of the sensor in each detector chip;

detection of unfavorable temperature distributions along the entire detector system;

recognition of incorrect functions on the chip that lead to abnormal temperature increases;

recognition of premature ageing due to increased temperature.

1. A radiation sensor (10) of an integrated type which is provided with at least one light-sensitive and/or X-ray-sensitive sensor element (11) whose output signal indicates the amount of radiation absorbed by the sensor element, and with at least one temperature sensor (12, 12a, 12b) whose output signal indicates the temperature prevailing at the temperature sensor.

2. A radiation sensor of an integrated type, notably as claimed in claim 1, which sensor is provided with at least one light-sensitive and/or X-ray-sensitive sensor element (11) whose output signal indicates the amount of radiation absorbed by the sensor element, and also with at least one further sensor element (12) which is sensitive to a physical quantity other than that whereto the light-sensitive and/or X-ray-sensitive sensor element (11) is sensitive, all sensor elements (11, 12) delivering similar output signals and being connectable to an evaluation unit (13) as similar components.

3. A radiation sensor as claimed in claim 1 or 2, characterized in that the light-sensitive and/or X-ray-sensitive sensor elements are arranged in the form of a matrix on the radiation sensor.

4. A radiation sensor as claimed in at least one of the claims 1 to 3, characterized in that it is provided with a temperature sensor (12a, 12b) which includes a current mirror with two paths (T₃-T₅, T₄-T₆), a respective bipolar transistor (T₁, T₂) being provided in each of the two paths, the base of said bipolar transistor being short-circuited to the collector, the surface areas of said bipolar transistors being different and the current (I) in the current paths being approximately proportional to the temperature of the bipolar transistors.

5. A radiation sensor as claimed in claim 4, characterized in that the current (I) in the current paths is coupled out as an output current (Iₒᵤₜ) via a further current mirror (T₇).

6. A radiation detector as claimed in claim 4 or 5, characterized in that the difference between the emitter-base voltages of the bipolar transistors (T₁, T₂) is determined by a coupling out circuit (A) so as to be delivered as an output voltage (Vₒᵤₜ).

7. A radiation detector, notably an X-ray detector for a computed tomography apparatus, which detector is provided with at least one radiation sensor (10) as claimed in at least one of the claims 1 to 6, as well as with an associated evaluation unit (13) for reading out and evaluating the output signals delivered by the radiation sensor.

8. A radiation detector as claimed in claim 7, characterized in that the radiation sensor (10) is provided with a temperature sensor (12, 12a, 12b) and that the evaluation unit (13) is arranged in such a manner that it corrects the output signals of the light-sensitive and/or X-ray sensitive sensor elements (11) of the radiation sensor by means of the temperature value measured by the temperature sensor.

9. A radiation detector as claimed in claim 7 or 8, characterized in that the radiation sensor (10) is provided with a temperature sensor (12, 12, 12b), and that the evaluation unit (13) is arranged in such a manner that it is capable of making a diagnosis concerning faults and/or ageing of the radiation sensor (10) on the basis of the temperature value measured by the temperature sensor.

10. An X-ray examination apparatus which is provided with a radiation detector, notably an X-ray detector, which includes at least one radiation sensor (10) as claimed in at least one of the claims 1 to 6. as well as an associated evaluation unit (13) for reading out and evaluating the output signals delivered by the radiation sensor.
